(19) United States
(12) Patent Application Publication
(10) Pub. No.: US 2012/0179738 A1
(43) Pub. Date: Jul. 12, 2012

(54) PORTLETIZATION SUPPORT SYSTEM, APPARATUS, METHOD, AND PROGRAM

(75) Inventor: Yoichi NAGAI, Tokyo (JP)

(73) Assignee: NEC Corporation, Tokyo (JP)

(21) Appl. No.: 13/344,056

(22) Filed: Jan. 5, 2012

(30) Foreign Application Priority Data
Jan. 6, 2011 (JP) 2011-001369

(51) Int. Cl. G06F 15/16

(52) U.S. Cl. 709/201

(57) ABSTRACT

A portletization support system for supporting portletization of a web application accompanied by plural of screen displays includes: an information storing device that stores screen information of the web application and link information for showing links between screens; a receiving device that receives necessity/non necessity information for showing whether a predetermined screen is necessary or not in accordance with the input operation of the creator; and a necessity/non necessity judgment device that judges whether a screen displayed by the web application is necessary or not on the basis of the screen information and the link information the information storing device stores and the necessity/non necessity information that the receiving device receives.

### CROSS-REFERENCE TO RELATED APPLICATION

This application is based upon and claims the benefit of priority from Japanese patent application No. 2011-001369, filed on Jan. 6, 2011, the disclosure of which is incorporated herein in its entirely by reference.

### BACKGROUND OF THE INVENTION

1. Field of the Invention

The present invention relates to a portletization support system, a web application screen transition branch cutting apparatus, an unnecessary tag-in-a-web-application deletion support apparatus, a portletization support method, and a portletization support program.

2. Description of the Related Art

In recent years, because a variety of web applications (referred to as APs hereinafter) are provided on the internet or on intranets, portal systems that integrally utilize functions of these APs are attracting much attention. Gadgets called portlets that realize functions of APs on portal sites (referred to portals for short hereinafter) are disposed on a portal system, and by providing functions of APs such as a function of collecting information and the like in a cross-sectoral manner, the convenience provided for users has been increasing.

In order to create a portlet that realizes functions, which are to be originally provided by an AP, on a portal, a developer develops a portlet with the use of an API (Application Program Interface) provided by the AP, or the developer realizes AP screens by using I flames and the like (this operation is referred to as clipping hereinafter).

In the former operation, although flexible functions based on the requirements of portlets can be realized, there is a disadvantage that the cost for development becomes large. In the latter operation, although there are advantages that the cost of development is low, and those not skilled in the portlet development art can creates portlets, there are disadvantages that it is impossible to realize detailed functions of portlets through customization and selection.

There are some products that provide development support functions that enable those not skilled in the portlet development art to develop portlets. For example, there is a product that provides a function for displaying an AP in a WYSIWYG manner so that it becomes easy for a user to select necessary parts of the AP and create a portlet.

As corporate portals have been evolving, portlets that provide functions closely related to business has been required. As a result, there is a possibility that a portal service administrator not skilled in the portlet development art in the field has to develop or modify portlets, therefore portlet support functions intended for those not skilled in the portlet art have been becoming highly important.

Technologies related to clipping of Web APs are disclosed in Japanese Unexamined Patent Publication No. 2006-107012 (Patent Document 1) and Japanese Patent No. 3703080 (Patent Document 2). In addition, disclosed in Japanese Unexamined Patent Publication No. 2007-164789 (Patent Document 3) is a method in which a user site is made by summarizing plural portlets.

### SUMMARY OF THE INVENTION

As described above, when an existing AP is portletized (in other words, when a portlet is made from the existing AP), a large screen originally displayed on the AP must be displayed in a small size to fit the portlet. In addition, if the AP includes a number of screens, it is necessary to extract only screens and parts within screens (HTML tags) that the portlet requires from the AP. In the above-described operation, if the AP is accompanied by many screens, a creator has to judges which screens or which parts within screens are necessary or not, which will leads to a problem in that a large amount of work is needed.

In addition, if a person, who is not skilled in the development art or does not have relevant business knowledge, performs such work, there is a possibility that, in the selection of screens or parts within screens, he/she may delete an access device to essentially necessary screens or parts within screens, or may leave unnecessary parts as they are. Therefore, there arises a problem in that a lot of check work to avoid the above-described situation is needed.

In addition, if a site has plural screens, methods described in Patent Documents 1 to 3 are not suitable to create a portlet that is equipped with neither too many nor too less functions (at least too less functions) of the site with the use of the site.

For example, in order to create a portlet that satisfies a creator's intention, it must be assured that the final selected result (in other words, a portlet made by the system) meets conditions specified by the creator. Otherwise it must be clarified how much assured it is that the selected result meets the conditions specified by the creator. However, methods described in Patent Documents 1 to 3 cannot assure the excess or deficiency, or the relationship between conditions specified by a user and a selected result.

An object of the present invention is to provide a portletization support system, a web application screen transition branch cutting apparatus, an unnecessary tag-in-a-web-application deletion support apparatus, a portletization support method, and a portletization support program that enable clipping with the accuracy of a portlet kept and without requesting a special development skill of a creator when an AP accompanied by plural screens is portletized.

As a exemplary aspect of the invention, a portletization support system according to the present invention is a system for supporting portletization of a web application accompanied by plural screen displays, and includes: an information storing device that stores screen information of the web application and link information for showing links between screens; a receiving device that receives necessity/non necessity information for showing whether a predetermined screen is necessary or not in accordance with the input operation of a creator; and a necessity/non necessity judgment device that judges whether a screen displayed by the web application is necessary or not on the basis of the screen information and the link information the information storing device stores and the necessity/non necessity information that the receiving device receives.

As another exemplary aspect of the invention, a web application screen transition branch cutting apparatus used when a portlet that is a site equipped with functions provided by a web application is made from the web application accompanied by plural screens, includes: an information storing device that stores information for showing a top screen on a web application accompanied by plural screens, which is selected as an initial screen of the portlet, or a certain selected part within the top screen, and information for showing a screen connected to a link, which derives from the top screen or the certain part within the top screen, or part within the screen, and link relationships between screens; a receiving device that receives judgment information that shows whether a screen is necessary or not in accordance with the input operation of a creator; and a judgment device that judges necessary screens or unnecessary screens if a certain screen is necessary or unnecessary by judging dependency relations from information showing link relationships between screens, in which the judgment device judges whether each screen is necessary or not by recursively making the judgment.

As another exemplary aspect of the invention, an unnecessary tag-in-a-web-application deletion support apparatus according to the present invention includes an unnecessary tag deleting device that, when a creator makes a portlet by taking out necessary functions from a screen of a web application, specifies necessary or unnecessary parts on HTML tags on a top screen, which is selected as an initial screen of the portlet from the web application, or on a screen deriving from the top screen in accordance with the operation of a creator, and identifies parts on other screens within the web application, which are common to the parts specified in accordance with the operation of the creator of the HTML tags, on the basis of component IDs, attribute information indicating class names, or tree structures, and deletes parts, which are common to the parts judged to be unnecessary in accordance with the operation of the creator, from the other screens, or leaves parts judged to be necessary as they are in accordance with the operation of the creator.

As another exemplary aspect of the invention, a portletization support method according to the present invention is a portletization support method for supporting portletization of a web application accompanied by plural screen displays, and include the steps of: obtaining screen information of the web application and link information for showing links between screens; receiving necessity/non necessity information for showing whether a predetermined screen is necessary or not in accordance with the input operation of a creator; and judging whether a screen displayed by the web application is necessary or not on the basis of the obtained screen information and link information, and the received necessity/non necessity information.

As another exemplary aspect of the invention, a portletization support program according to the present invention is a portletization support program for supporting portletization of a web application accompanied by plural screen displays, and causes a computer equipped with an information storing device that stores screen information of the web application and link information for showing links between screens to perform: reception processing that receives necessity/non necessity information for showing whether a predetermined screen is necessary or not in accordance with the input operation of a creator; and necessity/non necessity judgment processing that judges whether a screen displayed by the web application is necessary or not on the basis of the screen information, the link information, and the received necessity/non necessity information.

The present invention can support clipping with the accuracy of a portlet kept and without requesting a special development skill of a creator when an AP accompanied by plural screens is portletized.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1 is a block diagram showing a configuration example of a first embodiment of a portletization support system according to the present invention.

FIG. 2 is a sequence diagram of the first embodiment.

FIG. 3 is a flowchart showing an example of necessity/non necessity judgment processing made by a necessity judgment device 4.

FIG. 4 is an explanatory diagram showing an example of data held by an AP screen data storing device 1.

FIG. 5 is an explanatory diagram showing an example of data held by a judgment rule storing device 3.

FIG. 6 is a block diagram showing a configuration example of a second embodiment of the portletization support system.

FIG. 7 is a sequence diagram of the second embodiment.

FIG. 8 is a flowchart showing an example of judgment rule receiving support processing.

FIG. 9 is an explanatory diagram showing an example of data held by a judgment rule storing device 3 in the second embodiment.

FIG. 10 is a block diagram showing a configuration example of a third embodiment of the portletization support system.

FIG. 11 is a sequence diagram of the third embodiment.

FIG. 12 is an explanatory diagram showing an example of data held by a judgment rule storing device 3 in the third embodiment.

FIG. 13 is a block diagram showing a minimum configuration example of the portletization support system.

### DESCRIPTION OF EXEMPLARY EMBODIMENTS

A portletization support system of the present invention will be described in detail below with reference to the accompanying drawings.

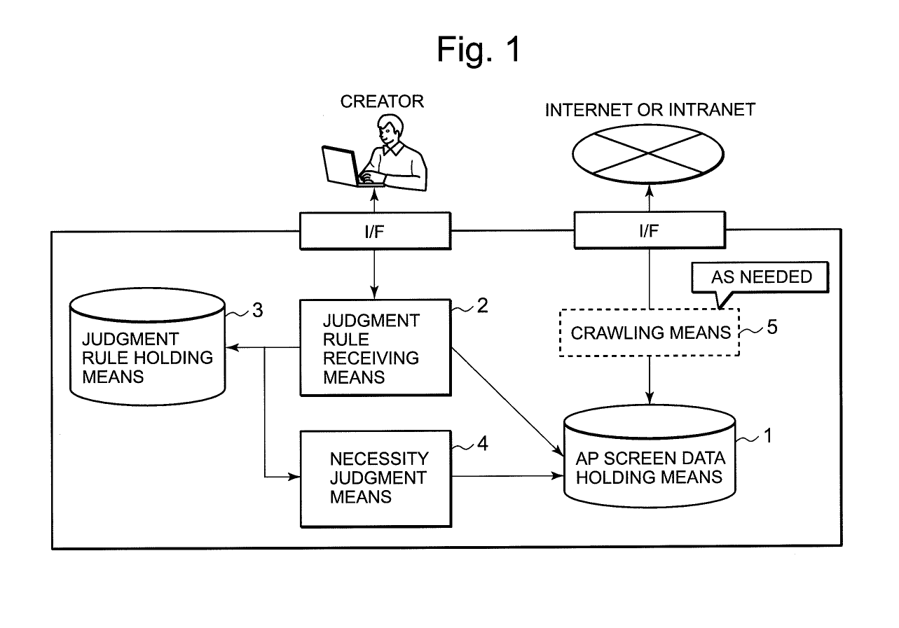

A first embodiment of a portletization support system according to the present invention will be described hereinafter. FIG. 1 is a block diagram showing a configuration example of a first embodiment of a portletization support system according to the present invention. An object of this embodiment is to aid a creator to delete unnecessary pages (screens) with less amount of work when the creator makes a portlet from an existing AP in a corporate portal. In addition, this work of deleting unnecessary pages (screens) is also referred to as web application screen transition branch cutting. Here, it will be assumed that an AP targeted by this embodiment is composed of plural screens (concretely, accompanied by plural screen displays).

As shown in FIG. 1, the portletization support system according to this embodiment includes an AP screen data storing device 1, a judgment rule receiving device 2, a judgment rule storing device 3, and a necessity judgment device 4. The portletization support system is realized by, for example, an information processing device such as a personal computer that operates in accordance with a program.

The AP screen data storing device 1 stores screens that compose an AP, and link information between screens. These pieces of information are, for example, collected by an after-described crawling device 5, and registered in the AP screen data storing device 1. The AP screen data storing device 1 is concretely realized by a storage device such as an optical disk device, or a magnetic disk device.

The judgment rule receiving device 2 displays collected AP screens and link relationships between screens. A creator inputs a judgment rule for judging whether a displayed screen is necessary or not. To put it concretely, the judgment rule receiving device 2 causes a display unit of a display device or the like to display the collected AP screens and link relationships between screens. In addition, the judgment receiving device receives the judgment rule for judging whether the screen is necessary or not in accordance with an input operation of the creator.

The judgment rule storing device 3 stores the judgment rule that the judgment rule receiving device 2 receives in accordance with the input operation of the creator. The judgment rule storing device 3 is concretely realized by a storage device such as an optical disk device, or a magnetic disk device.

The necessity judgment device 4 is equipped with a function for judging whether each screen that the AP screen data storing device 1 stores is necessary or not on the basis of the judgment rules that the judgment rule storing device 3 stores, and the screens and the link information between screens that the AP screen data storing device 1 stores. The necessity judgment device 4 is concretely realized by a CPU that is an information processing device running in accordance with programs.

Here, as shown in FIG. 1, the first embodiment of a portletization support system can include a crawling device 5 as needed. The crawling device 5 is concretely realized by a CPU that is an information processing device running in accordance with programs, and is equipped with a function for collecting screens of an existing AP and link information between screens. /

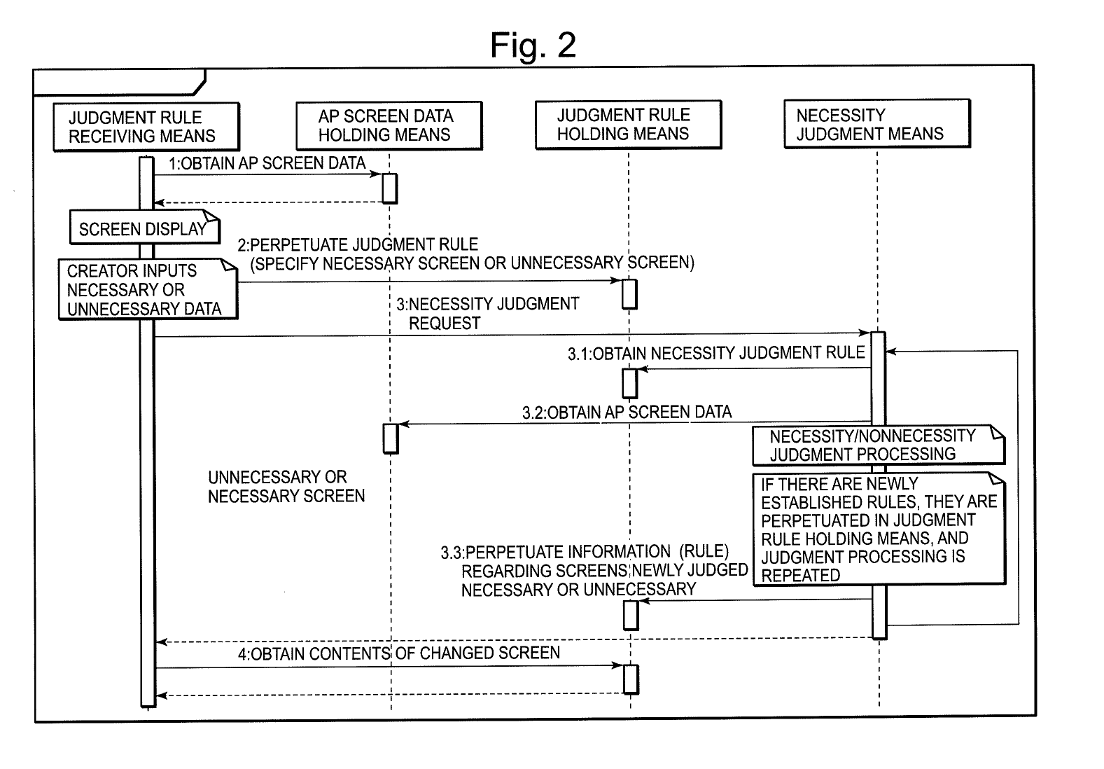

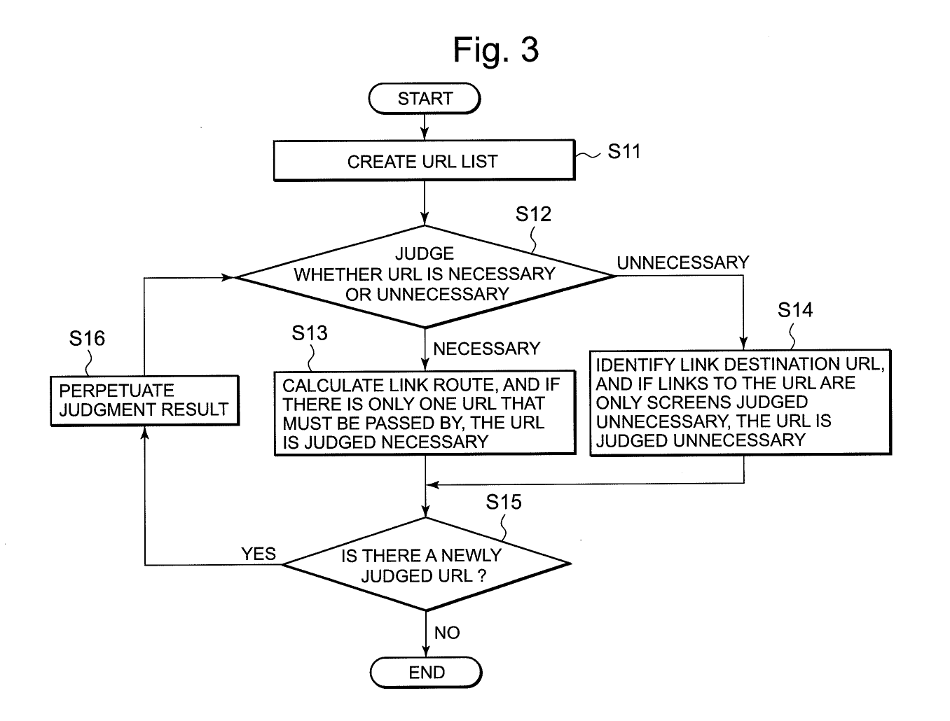

A process sequence of this embodiment will be described below. FIG. 2 shows an entire sequence diagram.

In order to make a portlet from an existing AP, when a creator specifies a targeted AP, the judgment rule receiving device 2 obtains screen data of the AP targeted for portletization from the AP screen data storing device 1 in accordance with the operation of the creator, and displays the data to the creator through a display screen. To put it concretely, the judgment rule receiving device 2 causes a display unit of a display device or the like to display the screen of the targeted AP and link information between screens that the judgment rule receiving device 2 extracts from the AP screen data storing device 1.

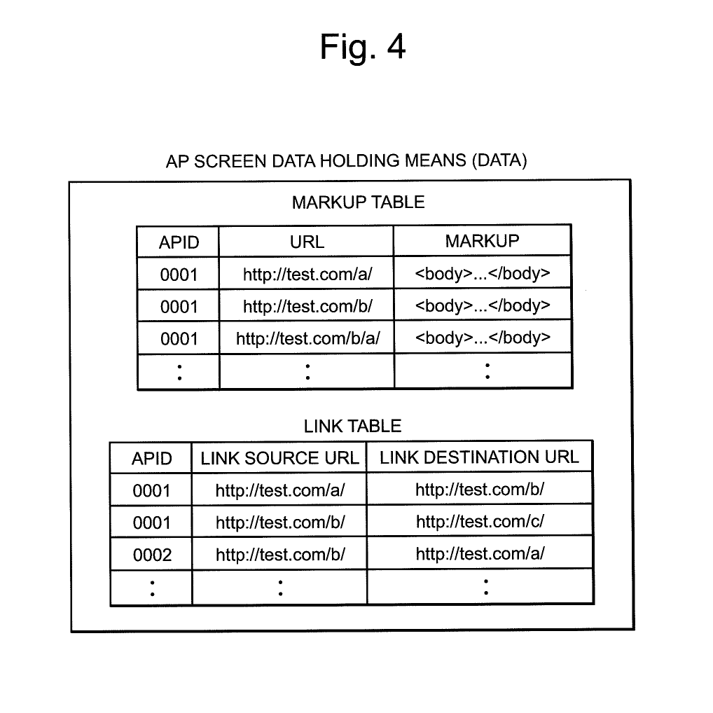

Here, the contents of data held by the AP screen data storing device 1 are HTML data for screen display (markup table) used by the judgment rule receiving device 2, and link structure data between screens (link table) used by the necessity judgment device 4 in order to analyze link structures. In addition, an APID is uniquely assigned to each AP. FIG. 4 is an explanatory diagram showing an example of data held by the AP screen data storing device 1.

When the judgment rule receiving device 2 displays a screen, the judgment rule receiving device 2 performs display control by outputting HTML tags of the relevant screen of the AP in a similar way that a typical browser displays a screen of an AP. In addition, when a user clicks an anchor within the screen, the judgment rule receiving device 2 controls the flow so that screen transition is made and a linked screen is displayed.

The judgment rule receiving device 2 is equipped with a UI using which a creator inputs a sign to show whether the creator needs a displayed screen is necessary or not, a UI using which the creator inputs a rule by which whether the screen is necessary or not is judged on the basis of features of URLs, and a UI using which the creator designates a top screen of a portlet at the portletization of each AP as well as a display unit for displaying screens. These UIs are realized, for example, by an input device such as a keyboard, a mouse, or a touch panel. The creator executes operations of inputting a result of judgment whether the displayed screen is necessary or not, a rule, and a top screen with the use of these UIs. Here, the result of judgment device a result of necessity/non necessity judgment regarding the screen made by the creator.

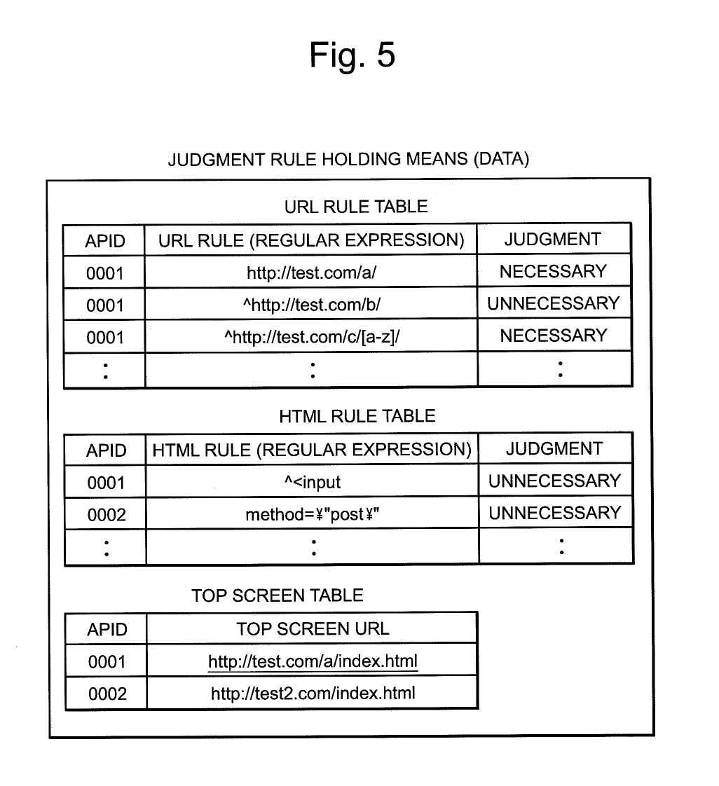

If the creator executes the operation of inputting the result of judgment or the rule, the judgment rule receiving device 2 outputs these rules to the judgment rule storing device 3 (in which a result of the necessity or non necessity judgment regarding each screen (URL) is considered as a judgment rule (on the basis of a feature of a URL)), and these rules are perpetuated. The representation that data or the like is perpetuated will be used in this embodiment hereinafter, and to put it concretely, this device that data is disposed in an auxiliary storage device or the like. FIG. 5 is an explanatory diagram showing an example of data held by the judgment rule storing device 3.

After outputting the data to the judgment rule storing device 3, the judgment rule receiving device 2 outputs an ID of an AP (often referred to as an APID) that is a targeted AP of portletization to the necessity judgment device 4, and asks the necessity judgment device 4 to make a necessity judgment. To put it concretely, the judgment rule receiving device 2 outputs the necessity judgment request along with the APID to the necessity judgment device 4.

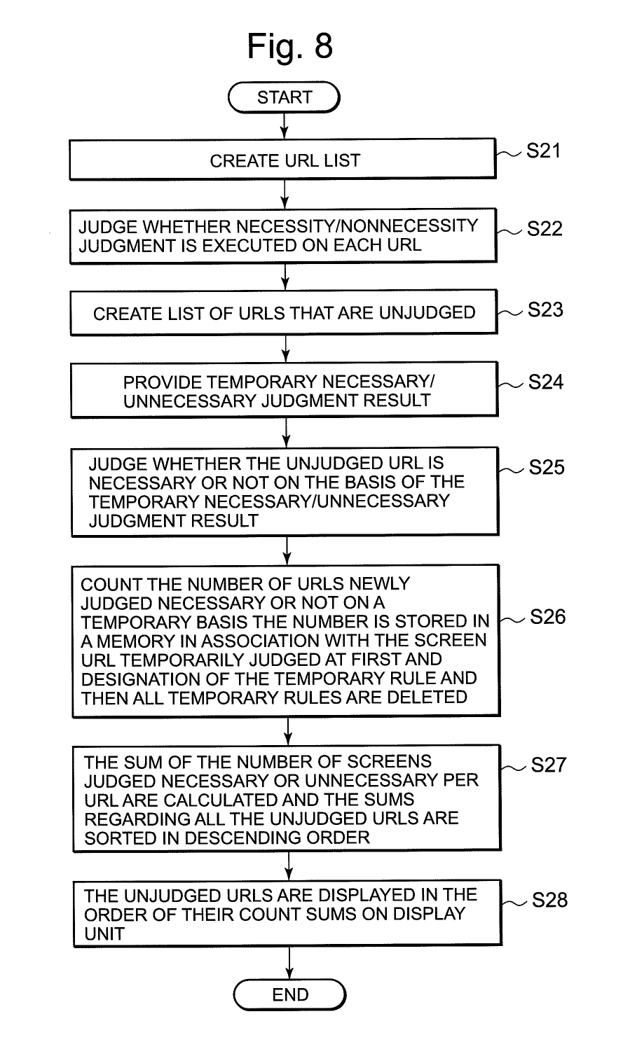

The necessity judgment device 4 that receives the necessity judgment request extracts a judgment rule (including a URL rule shown in FIG. 5, for example) from the judgment rule storing device 3 on the basis of the received APID. In a similar way, the necessity judgment device 4 extracts link information from a link table held by the AP screen data storing device 1 on the basis of the received APID. In addition, the necessity judgment device 4 judges whether there is an HTML rule corresponding to the received APID in the judgment rule storing device 3, and if there is one, the necessity judgment device 4 also extracts HTML information from the markup table. Afterward, the necessity judgment device 4 makes necessity/non necessity judgment regarding each screen on the basis of these collected pieces of information. Concrete judgment steps will be described with reference to FIG. 8.

First, the necessity judgment device 4 creates a URL list that includes URLs of screens that constitute the AP without omission and with no overlaps with the use of the link information extracted from the AP screen data storing device 1 (at step S11).

Next, the necessity judgment device 4 makes necessity/non necessity judgment regarding each URL included in the created URL list on the basis of a URL rule that is a judgment rule (on the basis of HTML information if there is a HTML rule) (at step S12). At this moment, because judgment rules are registered on the basis of judgment results and rules input by the creator, necessity/non necessity judgments regarding all the URLs are not always shown.

Next, the necessity judgment device 4 calculates a link route from a top screen of the AP regarding each URL that is judged as necessary at step S12, and if there is only one URL that must be passed by in the link route, the necessity judgment device 4 judges that the URL is necessary (at step S13).

In addition, the necessity judgment device 4 identifies URLs that derive from each URL (URLs connected to the link) that is judged to be unnecessary at step S12 on the basis of link information. Here, if each URL that is identified as above does not have links other than the link from the screen (URL) that is judged to be unnecessary, the necessity judgment device 4 judges that the identified URL is unnecessary (at step S14).

Next, if there are URLs that are newly judged to be necessary or unnecessary (that is, URLs that are new targets of necessity/non necessity judgment) at steps S13 or S14, the necessity judgment device 4 sends the rules (that is, the results of necessity/non necessity judgment) to the judgment rule storing device 3, and these rules are perpetuated. In addition, the necessity judgment device 4 executes the process at step 13 or step 14 on the URLs that are newly judged to be necessary or unnecessary (at steps S15 and S16).

After the necessity/non necessity judgment is completed regarding all the URLs, the necessity judgment device 4 returns the control to the judgment rule receiving device 2. Next, if there are screens (URLs) regarding which the necessity/non necessity judgments are newly made (in other words, there are screens (URLs) regarding which the necessity/non necessity judgments are made not by the creator, but by the necessity judgment device 4), the judgment rule receiving device 2 controls the flow so that the updated rules (newly found pieces of necessity/non necessity information) are displayed on the display unit.

As described above, in this embodiment, when an existing AP is portletized, the judgment of necessity/non necessity judgment regarding the AP is made in accordance with the judgment rule inputted by a creator, and the result of judgment is outputted. Therefore, this embodiment can support creating, from a site that includes plural pages, a portlet that is equipped with neither too many nor too less functions (at least too less functions) of the site. In other words, this embodiment can support creation of a portlet by assuring clipping with the accuracy of a portlet kept.

When a creator who is engaged in portal management without the development skill makes a portlet from an existing AP in a corporate portal, this embodiment makes it possible that the creator can make necessity/non necessity judgments regarding screens with minimum effort in work of deleting unnecessary screens of the AP, with the result that the amount of work can be reduced.

### Second Embodiment

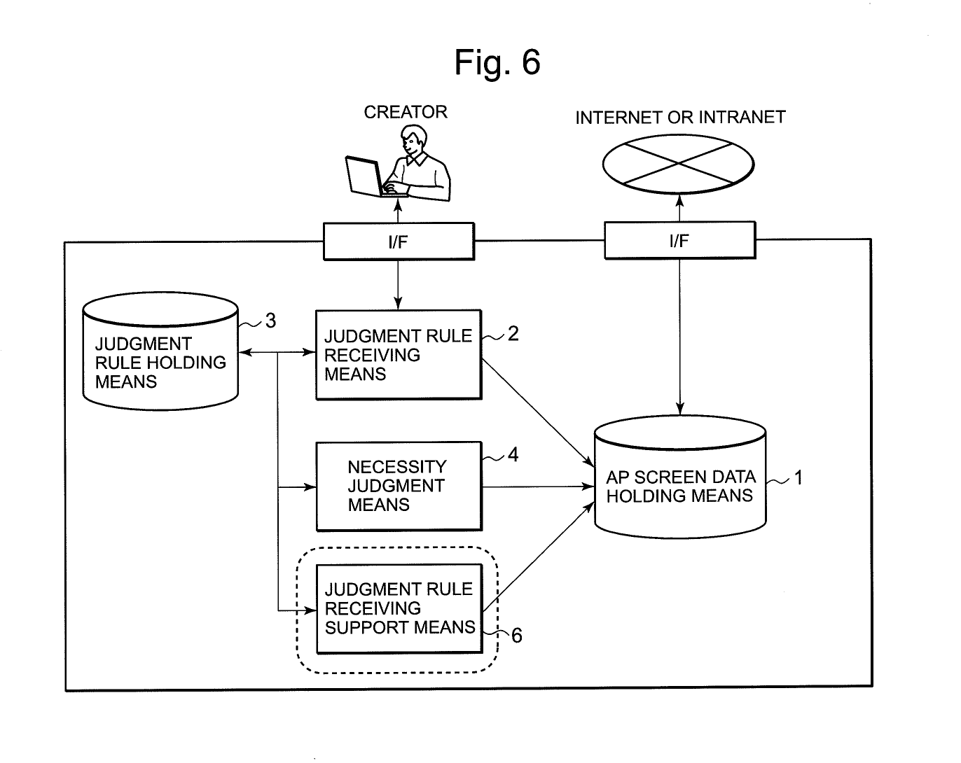

A second embodiment according to the present invention will be described hereinafter. This embodiment includes a judgment rule receiving support device 6 equipped with a function that suggests a creator which screen he/she should judge in order that he/she can effectively develop portletization as well as the configuration of the first embodiment. FIG. 6 is a block diagram showing a configuration example of the second embodiment of the portletization support system.

As shown in FIG. 6, the portletization support system according to this embodiment includes an AP screen data storing device 1, a judgment rule receiving device 2, a judgment rule storing device 3, a necessity judgment device 4, and a judgment rule receiving support device 6.

The AP screen data storing device 1 stores collected screens and link information between screens. The AP screen data storing device 1 is concretely realized by a storage device such as an optical disk device, or a magnetic disk device.

The judgment rule receiving device 2 displays the collected screens and link relationships between screens, and a creator inputs a judgment rule for judging whether a displayed screen is necessary or not. To put it concretely, the judgment rule receiving device 2 has a function for causing a display unit of a display device or the like to display the collected screens and link relationships between screens. In addition, the judgment rule receiving device has a function for receiving judgment rules for judging whether screens are necessary or not in accordance with the input operation of the creator.

The judgment rule storing device 3 stores judgment rules that the judgment rule receiving device 2 receives in accordance with the input operation of the creator. The judgment rule storing device 3 is concretely realized by a storage device such as an optical disk device, or a magnetic disk device.

The necessity judgment device 4 is equipped with a function for judging whether each screen that the AP screen data storing device 1 stores is necessary or not on the basis of the judgment rules that the judgment rule storing device 3 stores, and the screens and the link information between screens that the AP screen data storing device 1 stores. The necessity judgment device 4 is concretely realized by a CPU that is an information processing device running in accordance with programs.

The judgment rule receiving support device 6 has a function for calculating screens of which parts are known to be necessary or unnecessary if a certain screen that the AP screen data storing device stores is known to be necessary or unnecessary with the use of the necessity judgment device 4. In addition, the judgment rule receiving support device 6 has a function for outputting calculation results to the judgment rule receiving device 2 to cause the calculation results to be presented (for example, to be displayed) to the creator.

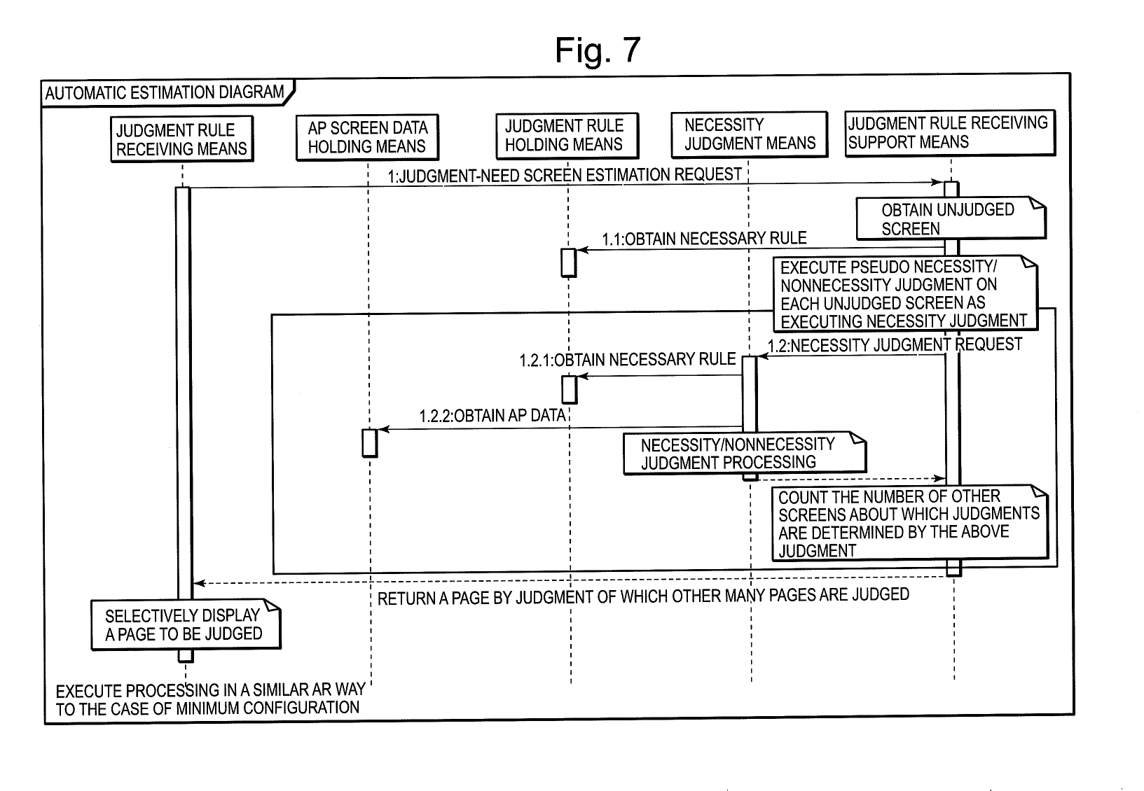

A process sequence of this embodiment will be described below. FIG. 7 shows an entire sequence diagram.

In order to make a portlet from an existing AP, when a creator specifies a targeted AP, the judgment rule receiving device 2 obtains screen data of the AP targeted for portletization from the AP screen data storing device 1 in accordance with the operation of the creator, and displays the data to the creator through a display screen. To put it concretely, the judgment rule receiving device 2 causes a display unit of a display device or the like to display the screen of the targeted AP and link information between screens that the judgment rule receiving device 2 extracts from the AP screen data storing device 1.

Here, the contents of data held by the AP screen data storing device 1 are a markup table, and a link table.

The judgment rule receiving device 2 has a function that, if a creator makes a judgment about necessity or non necessity of a certain screen, and executes an input operation, many other screens that can be judged by the input operation, that is, information for supporting the input operation of the creator, as well as information and UIs that the first embodiment is equipped with, are shown in a display unit.

When the creator executes the operation of inputting a top screen regarding an AP which the creator wants to portletize, the judgment rule receiving device 2 sends judgment-need-screen estimation request to the judgment rule receiving support device 6. The judgment rule receiving support device 6 that receives the request accesses the judgment rule receiving device 2 and the AP screen data storing device 1, obtains necessary information, and identifies unjudged URLs by performing the following process. This process will be described with reference to FIG. 8.

First, the judgment rule receiving support device 6 creates a URL list that includes URLs of screens that constitute the AP without omission and with no overlaps with the use of the link information obtained from the AP screen data storing device (at step S21).

Next, the judgment rule receiving support device 6 judges whether necessity/non necessity judgment regarding each URL included in the created URL list is made or not on the basis of a URL rule that is a judgment rule (on the basis of HTML information if there is a HTML rule) (at step S22).

Next, the judgment rule receiving support device 6 creates a list that includes URLs on which necessity/non necessity judgment is not made (at step S23).

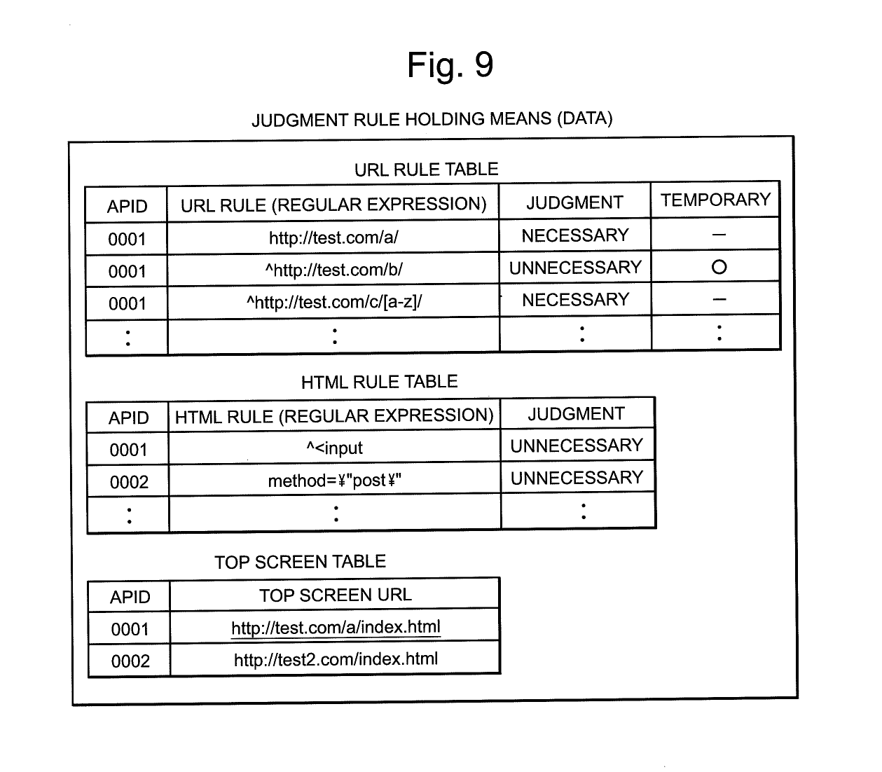

Next, the judgment rule receiving support device 6 provides a result of a temporary necessity/non necessity judgment that is temporarily drew for convenience (often referred to as a temporary judgment hereinafter) for each unjudged URL included in the created list, and sends the result to the judgment rule storing device 3 in order to perpetuate it as a temporary rule (at step S24). In this case, in order to designate some results as temporary rules, a column for identifying temporary rules is added to a URL rule table held by the judgment rule storing device 3 as shown in FIG. 9.

Next, the judgment rule receiving support device 6 asks the necessity judgment device 4 to make necessity/non necessity judgments of an unjudged URL. To put it concretely, the judgment rule receiving support device 6 sends a necessity/non necessity judgment request to the necessity judgment device 4.

After designating the temporary rule, the judgment rule receiving support device 6 sends a necessity judgment request to the necessity judgment device 4 to check the effect of designating the temporary rule (degree of finding of necessity/non necessity regarding the unjudged screens). In response to the request, the necessity judgment device 4 makes necessity/non necessity judgments on the unjudged screens (URLs), and writes the results in the judgment rule storing device 3 as temporary rules in a similar way in the case of the first embodiment (at step S25). Making a necessity/non necessity judgment as described above on the basis of a temporary rule is referred to as making a pseudo-necessity/non necessity judgment. Afterward, the necessity judgment device 4 returns the control to the judgment rule receiving support device 6.

The judgment rule receiving support device 6 accesses the judgment rule storing device 3, counts the number of screens newly judged necessary or unnecessary on a temporary basis (in other words, the number of temporary rules written at step S25). The number is stored in a memory in association with the screen URL temporarily judged at first and the designation of the temporary rule. Next, the judgment rule receiving support device 6 deletes all the temporary rules held by the judgment rule storing device 3 (at step S26).

Afterward, the judgment rule receiving support device 6 similarly provides a temporary judgment (or a judgment opposite to that given to the former screen) for the next unjudged screen, and counts the number of screens judged to be necessary or unnecessary by the necessity judgment device 4 on the basis of the temporary judgment.

If the effects of temporary judgments of necessity/non necessity regarding all unjudged URLs (the counts of screens judged necessary or unnecessary) are found, the judgment rule receiving support device 6 calculates the sum of the number of screens judged necessary or unnecessary (the sum of both number of screens judged necessary and number of screens judged unnecessary) per URL, sorts the sums regarding all the unjudged URLs in descending order, and sends the processing result to the judgment rule receiving device 2 (at step S27).

The judgment rule receiving device 2 that receives the processing results from the judgment rule receiving support device 6 displays the unjudged URLs in descending order of their count sums on a display unit (at step S28) to prompt the creator to make inputting.

As described above, in this embodiment, if a certain screen is known to be necessary or unnecessary, it can be found screens of which parts are known to be necessary or unnecessary. Therefore, this embodiment can provide a creator with the support for the input operation of the creator by selectively displaying screens on which the creator must make judgments as well as the effects that the first embodiment provides.

### Third Embodiment

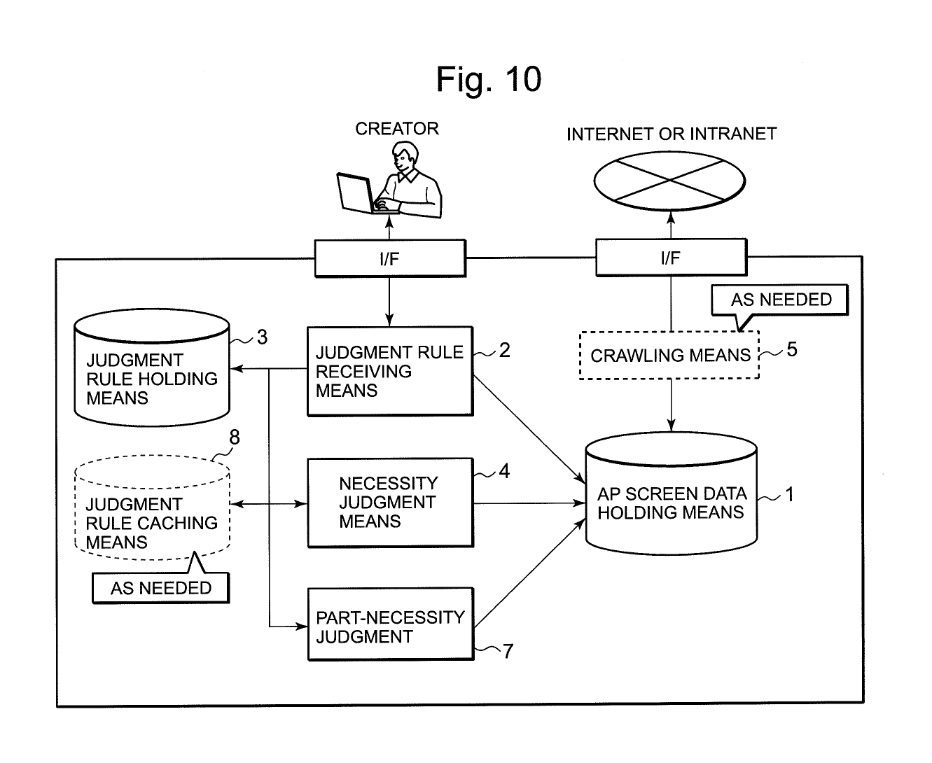

A third embodiment according to the present invention will be described hereinafter. This embodiment includes a function for selecting part within a screen of an existing AP and a function for suggesting whether a portletization development of the part of the screen of the existing AP can be made or not on the basis of judgments of necessity or non necessity made by a creator as well as the configuration of the first embodiment. FIG. 10 is a block diagram showing a configuration example of the third embodiment of the portletization support system.

As shown in FIG. 10, the portletization support system according to this embodiment includes an AP screen data storing device 1, a judgment rule receiving device 2, a judgment rule storing device 3, a necessity judgment device 4, and a part-necessity judgment device 7.

The AP screen data storing device 1 stores collected screens and link information between screens. The AP screen data storing device 1 is concretely realized by a storage device such as an optical disk device, or a magnetic disk device.

The judgment rule receiving device 2 displays the collected screens and link relationships between screens, and a creator inputs a judgment rule for judging whether a displayed screen is necessary or not. To put it concretely, the judgment rule receiving device 2 has a function for causing a display unit of a display device or the like to display the collected screens and link relationships between screens. In addition, the judgment rule receiving device has a function for receiving judgment rules for judging whether screens are necessary or not in accordance with the input operation of the creator.

The judgment rule storing device 3 stores judgment rules that the judgment rule receiving device 2 receives in accordance with the input operation of the creator. The judgment rule storing device 3 is concretely realized by a storage device such as an optical disk device, or a magnetic disk device.

The necessity judgment device 4 is equipped with a function for judging whether each screen that the AP screen data storing device 1 stores is necessary or not on the basis of the judgment rules that the judgment rule storing device 3 stores, and the screens and the link information between screens that the AP screen data storing device 1 stores. The necessity judgment device 4 is concretely realized by a CPU that is an information processing device running in accordance with programs.

The part-necessity judgment device 7 has a function for judging whether parts within each screen held by the AP screen storing device 1 are necessary or not on the basis of judgment rules regarding parts within screens (HTML tags) held by the judgment rule storing device 3 and screens held by the AP screen storing device 1. The part-necessity judgment device 7 is concretely realized by a CPU that is an information processing device running in accordance with programs.

In addition, as shown in FIG. 10, the part-necessity judgment device 7 can include a judgment rule caching device 8. The judgment rule caching device 8 is concretely realized by a storage device such as an optical disk device, a magnetic disk device, or a memory. The judgment rule caching device 8 temporary stores data dealt with by, for example, the judgment rule receiving device 2, the necessity judgment device 4, and the part-necessity judgment device 7 at their processes.

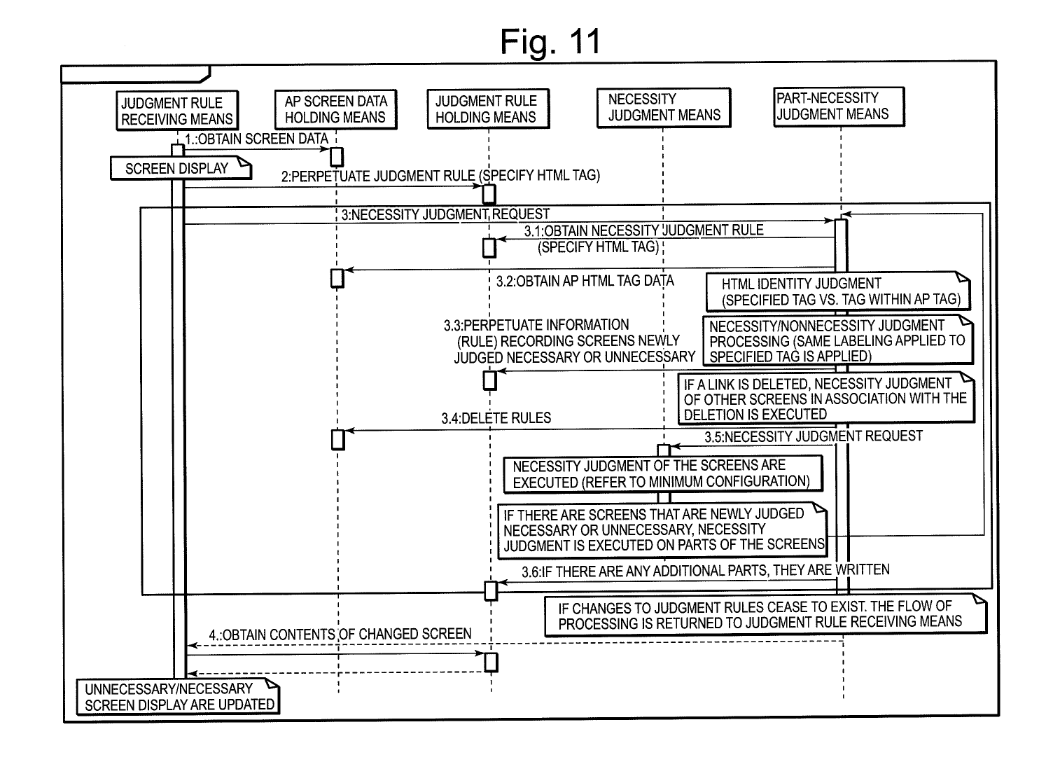

A process sequence of this embodiment will be described below. FIG. 11 shows an entire sequence diagram.

In order to make a portlet from an existing AP, when a creator specifies a targeted AP, the judgment rule receiving device 2 obtains screen data of the AP targeted for portletization from the AP screen data storing device 1 in accordance with the operation of the creator, and displays the data to the creator through a display screen. To put it concretely, the judgment rule receiving device 2 causes a display unit of a display device or the like to display the screen of the targeted AP and link information between screens that the judgment rule receiving device 2 extracts from the AP screen data storing device 1.

In this embodiment, the judgment rule receiving device 2 is equipped with a UI using which part of a displayed screen that is necessary or not can be inputted as well as functions similar to those that the first embodiment is equipped with, The creator executes an operation for inputting a necessity/non necessity judgment regarding the part of the displayed screen using the UI. The judgment rule receiving device 2 designates a necessary part or an unnecessary part with the use of xPath (XML Path Language) in accordance with the operation of the creator.

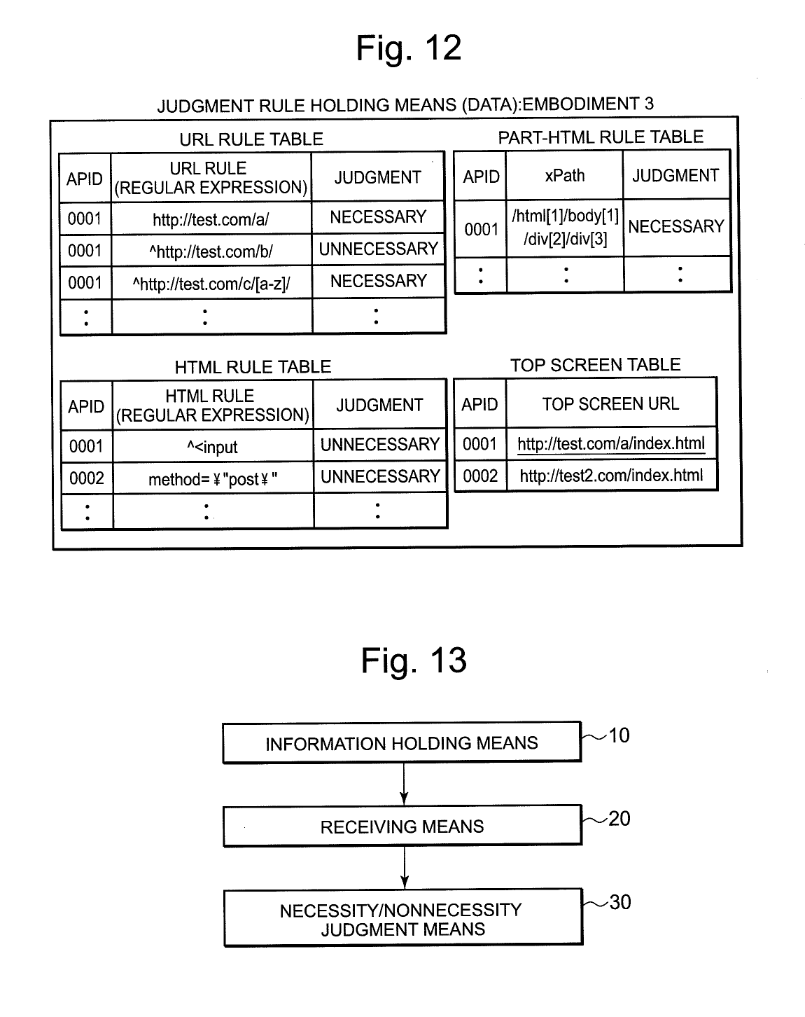

If the creator executes the operation of inputting the necessity/non necessity judgment, the judgment rule receiving device 2 outputs the judgment rule to the judgment rule storing device 3 (in which a necessity or non necessity judgment regarding each screen (URL) or a necessity or non necessity judgment regarding part of the screen is considered as a judgment rule (on the basis of a feature of a URL)) in accordance with the operation of the creator, and the rule is perpetuated. FIG. 12 is an explanatory diagram showing an example of data held by the judgment rule storing device 3 in this embodiment.

After outputting the data to the judgment rule storing device 3, the judgment rule receiving device 2 sends an ID of a targeted AP to the part-necessity judgment device 7, and asks the necessity judgment device 7 to make a necessity judgment. To put it concretely, the judgment rule receiving device 2 outputs the necessity judgment request along with the APID to the part-necessity judgment device 7.

The part-necessity judgment device 7 that receives the necessity judgment request extracts a judgment rule on the basis of the received APID from a part-HTML rule table held by the judgment rule storing device 3. In a similar way, the part-necessity judgment device 7 extracts HTML information from a markup table held by the AP screen data storing device 1 on the basis of the received APID.

Next, the part-necessity judgment device 7 judges whether there is part within each screen corresponding to the judgment rule regarding part held by the judgment rule storing device 3 or not on the basis of these collected pieces of information. To put it concretely, if there is a corresponding part on the basis of xPath, the part-necessity judgment device 7 judges that the part is the same. In addition, the part-necessity judgment device 7 identifies parts within other screens within the web application, which are common to the part specified in accordance with the operation of the creator on the basis of component IDs, attribute information indicating class names, or tree structures, for example.

If it is judged that there is part corresponding to the judgment rule, the part-necessity judgment device 7 applies the judgment content made by the judgment rule (necessary or unnecessary) to the part corresponding to the judgment rule. In addition, if the part corresponding to the judgment rule is unnecessary and a link is included inside the part, the part-necessity judgment device 7 assumes that the link has ceased to exist, and deletes the relevant link information from the AP screen data storing device 1 (in other words, the part-necessity judgment device 7 deletes the link that derives from the HTML tag, and executes transition screen branch cutting). In addition, the part-necessity judgment device 7 asks the necessity judgment device 4 to make a necessity/non necessity judgment of each screen (not a necessity/non necessity judgment of each part).

After the necessity/non necessity judgment is completed regarding all the screens, the necessity judgment device 4 returns the control to the judgment rule receiving device 2. Next, if there are screens regarding which the necessity/non necessity judgments are newly made, the judgment rule receiving device 2 controls the flow so that the updated rules (newly found pieces of necessity/non necessity information) are displayed on the display unit.

As described above, in this embodiment, necessities or non necessities of parts within each screen held by the AP screen data storing device 1 are judged on the basis of judgment rules regarding parts within the screen held by the judgment rule storing device 3 and the screen held by the AP screen data storing device 1. Therefore, this embodiment has an advantage that the load of clipping work can be alleviated with the accuracy of a portlet kept by showing judgments even regarding parts within screens as well as the advantages that the first embodiment has. In addition, this embodiment can be equipped with the judgment rule receiving support device 6 described in the second embodiment.

As described above, the portletization support system according to the present invention includes: the AP screen data storing device that stores collected screens and link information between screens; the judgment rule receiving device that displays a collected screen and link information between screens, in which a creator inputs a judgment rule for judging whether the displayed screen is necessary or not; the judgment rule storing device that stores the judgment rule that is inputted in accordance with the operation of the creator; and the necessity judgment device that judges whether each screen that the AP screen data storing device stores is necessary or not on the basis of judgment rules that the judgment rule storing device stores and the screens and the link information that the AP screen data storing device 1 stores. In addition, the portletization support system according to the present invention can include the judgment rule receiving support device that calculates screens of which parts are known to be necessary or unnecessary with the use of the necessity judgment device if a certain screen that the AP screen data storing device stores is known to be necessary or unnecessary.

Next, a minimum configuration of the portletization support system according to the present invention will be described below. FIG. 13 is a block diagram showing a minimum configuration example of the portletization support system. As shown in FIG. 13, the portletization support system includes an information storing device 10 that stores screen information of websites and link information that shows links between screens; a receiving device 20; and a necessity/non necessity judgment device 30 as a minimum number of components.

In the portletization system of the minimum configuration, when the receiving device 20 receives necessity/non necessity information that shows necessity or non necessity of a predetermined screen in accordance with the input operation of a creator, the necessity/non necessity judgment device 30 judges whether a screen displayed in a web application on the basis of the screen information and the link information held by the information storing device 10 and the necessity/non necessity information received by the receiving device 20 . . . .

Therefore, when a web application accompanied by plural screens is portletized, this portletization support system of the minimum configuration can support this portletization by clipping the web application without requesting a special development skill of a creator and with the accuracy of a portlet kept.

In this embodiment, distinguishing configurations of a portletization support system shown below in (1), a web application screen transition branch cutting apparatus shown below in (2) to (7), and an unnecessary tag-in-a-web-application deletion support apparatus shown below in (8) are described.

(1) The portletization support system is a system for supporting portletization of a web application accompanied by plural screen displays, and includes: an information storing device that stores screen information of the web application and link information for showing links between screens (, where the information storing device is realized, for example, by the AP screen data storing device 1); a receiving device that receives necessity/non necessity information (for example, a judgment result inputted by a creator) for showing whether a predetermined screen is necessary or not in accordance with the input operation of the creator (, where the receiving device is realized, for example, by the judgment rule receiving device 2); and a necessity/non necessity judgment device that judges whether a screen displayed by the web application is necessary or not on the basis of the screen information and the link information held by the information storing device and the necessity/non necessity information received by the receiving device (, where the necessity/non necessity judgment device is realized, for example, by the necessity judgment device 4).

(2) The web application screen transition branch cutting apparatus (, which is realized by, for example, an information processing device such as a personal computer that operates in accordance with a program,) used when a portlet that is a site equipped with functions provided by a web application is made from the web application accompanied by plural screens, includes: an information storing device that stores information for showing a top screen on the web application accompanied by plural screens, which is selected as an initial screen of the portlet, or a certain selected part within the top screen, and information for showing a screen connected to a link, which derives from the top screen or the certain part of the top screen, or part within the screen, and link relationships between screens (, where the information storing device is realized, for example, by the AP screen data storing device 1); a receiving device that receives judgment information that shows whether a screen is necessary or not in accordance with the input operation of a creator (, where the receiving device is realized, for example, by the judgment rule receiving device 2); and a judgment device that judges necessary screens or unnecessary screens if a certain screen is necessary or unnecessary by judging dependency relations from information showing link relationships between screens (, where the judgment device is realized, for example, by the necessity judgment device 4), in which the judgment device judges whether each screen is necessary or not by recursively making the judgment.

(3) In the web application screen transition branch cutting apparatus, the judgment device can be configured so that, when a link from the top screen to a screen that is judged to be necessary is traced, if there is a screen that is a unique relay point, the screen is newly judged to be a necessary screen.

(4) In the web application screen transition branch cutting apparatus, the judgment device can be configured so that, if a screen has a link only from a screen that is judged to be unnecessary, the screen is newly judged to be an unnecessary screen.

(5) In the web application screen transition branch cutting apparatus, the receiving device can be configured to receive information for showing rules between screens that are necessary for judging whether a screen is necessary or not as well as judgment information for showing a screen is necessary or not in accordance with the input operation of the creator; and the judgment device can be configured to judge whether a screen is necessary or not on the basis of the judgment rules shown by the information received by the receiving device.

(6) The web-application-screen-transition-branch cutting apparatus can be configured to include: the temporary judgment result providing device that provides temporary necessary or unnecessary judgment results for all targeted screens to be judged or some of the targeted screens when a creator judges whether a screen of a web application is necessary or not, in order to know that, if judgment information about necessity or non necessity of a certain screen is input, which other screens are known to be necessary or unnecessary or become easy to be judged necessary or unnecessary (, where the temporary judgment result providing device is realized, for example, by the judgment rule receiving support device 6), wherein the judgment device judges whether other screens are necessary or unnecessary on the basis of the temporary judgment results provided by the temporary judgment result providing device; the count device that measures how many other screens are temporarily judged and counts the number (, where the count device is realized, for example, by the judgment rule receiving support device 6); and a display control device that causes a display unit to display screens having a large number of counts that is given through the measurement and counting of the count unit in order to prompt the creator to make a judgment (, where the display control device is realized, for example, by the judgment rule receiving 2).

(7) The web application screen transition branch cutting apparatus can be configured to include: an unnecessary tag deleting device that, when a creator makes a portlet by taking out necessary functions from a screen of a web application, specifies necessary or unnecessary parts on HTML tags on a top screen, which is selected as an initial screen of the portlet from the web application, or on a screen deriving from the top screen in accordance with the operation of the creator, and

identifies parts on other screens within the web application, which are common to the parts specified in accordance with the operation of the creator on the HTML tags, on the basis of component IDs, attribute information indicating class names, or tree structures, and deletes the parts common to the parts judged to be unnecessary from the other screens in accordance with the operation of the creator, or leaves the parts judged to be necessary as they are in accordance with the operation of the creator (, where unnecessary tag deleting device is realized, for example, by the part-necessity judgment device 7); and a screen transition branch cutting device that executes cutting of transiting screens' branches by deleting links deriving from the HTML tags deleted by the unnecessary tag deleting device (, where the screen transition branch cutting device is realized, for example, by the part-necessity judgment device 7).

(8) The unnecessary tag-in-a-web-application deletion support apparatus includes an unnecessary tag deleting device that, when a creator makes a portlet by taking out necessary functions from a screen of a web application, specifies necessary or unnecessary parts on HTML tags on a top screen, which is selected as an initial screen of the portlet from the web application, or on a screen deriving from the top screen in accordance with the operation of the creator, and identifies parts on other screens within the web application, which are common to the parts specified in accordance with the operation of the creator of the HTML tags, on the basis of component IDs, attribute information indicating class names, or tree structures, and deletes parts, which are common to the parts judged to be unnecessary in accordance with the operation of the creator, from the other screens, or leaves parts judged to be necessary as they are in accordance with the operation of the creator (, where the unnecessary tag deleting device is realized, for example, by the part-necessity judgment device 7).

Other features of the invention may include, but are not limited to the following.

An unnecessary tag deleting device is a web application screen transition branch cutting apparatus that, when identifying parts, which are common to parts within a screen within a web application specified in accordance with the operation of a creator, on other screens within the web application, judges whether the former parts are common to the latter parts or not on the basis of HTML tags or on whether the same style class is used or not.

An unnecessary tag deleting device is an unnecessary tag-in-a-web-application deletion support apparatus according to claim 8 that, when identifying parts, which are common to parts of a screen within a web application specified in accordance with the operation of a creator, on other screens within the web application, judges whether the former parts are common to the latter parts or not on the basis of HTML tags or on whether the same style class is used or not.

The present invention is applicable to the creation of a portlet, that is, a site in which functions provided by a web application are summarized, such as a portlet on a corporate portal made by taking out necessary functions from an existing web application accompanied by plural screens.

The present invention has been described in detail. However, it should be appreciated that various changes may be made to the present invention without departing from its spirits and be covered by the claims.

Furthermore, it is the inventor's intent to retain all equivalents of the claimed invention even if the claims are amended during prosecution.

What is claimed is:

1. A portletization support apparatus comprising:
a information storing device which stores screen information and link information,
wherein the screen information shows a top screen on a web application accompanied by a plurality of screens or a certain selected part within the top screen and link information shows link relationships between the top screen or the certain selected part of the screen information and a screen connected to a link which derives from the top screen or the certain selected part;
a judgment rule storing device which stores judgment rules that show whether a screen is necessary or not in accordance with a user input operation; and
a judgment device which judges dependency relationships based on the link information and judges necessary screens or unnecessary screens based on the judgment rules and the dependency relationships,
wherein the judgment device judges whether each screen is necessary or not by recursively making the judgment.

2. The portletization support apparatus as claimed in claim 1,
wherein the judgment device traces a link from the top screen to a screen that is judged to be necessary and judges a screen that is a unique relay point as a necessary screen.

3. The portletization support apparatus as claimed in claim 1,
wherein the judgment device judges a screen has a link only from a screen that is judged to be unnecessary as an unnecessary screen.

4. The portletization support apparatus as claimed in claim 1,
wherein the judgment rule storing device stores further information which shows judgment rules between screens that are necessary for judging whether a screen is necessary or not as well as judgment information for showing a screen is necessary or not in accordance with the user input operation; and
wherein the judgment device judges whether a screen is necessary or not based on the judgment rules.

5. The portletization support apparatus as claimed in claim 1 further comprising:
a temporary judgment result providing device that provides temporary necessary or unnecessary judgment results for all targeted screens to be judged or some of the targeted screens when a user judges whether a screen of a web application is necessary or not,
wherein the judgment device judges whether other screens are necessary or unnecessary on the basis of the temporary judgment results provided by the temporary judgment result providing device;
a count device that measures how many other screens are temporarily judged by the judgment device and counts the number; and
a display control device that causes a display unit to display screens having a large number of counts that is given through the measurement and counting of the count unit in order to prompt the user to make a judgment.

6. A portletization support method comprising:
storing screen information and link information,
wherein the screen information shows a top screen on a web application accompanied by a plurality of screens or a certain selected part within the top screen and link information shows link relationships between the top screen or the certain selected part of the screen information and a screen connected to a link which derives from the top screen or the certain selected part;
storing judgment rules that show whether a screen is necessary or not in accordance with a user input operation; and
judging dependency relationships based on the link information
and necessary screens or unnecessary screens based on the judgment rules and the dependency relationships,
wherein, in the step of judging, judges whether each screen is necessary or not by recursively making the judgment.

7. The portletization support method as claimed in claim 6,
wherein, in the step of judging, tracing a link from the top screen to a screen that is judged to be necessary and judging a screen that is a unique relay point as a necessary screen.

8. The portletization support method as claimed in claim 6,
wherein, in the step of judging, judging a screen has a link only from a screen that is judged to be unnecessary as an unnecessary screen.

9. The portletization support method as claimed in claim 6,
wherein, in the step of storing the judgment rules, storing further information which shows judgment rules between screens that are necessary for judging whether a screen is necessary or not as well as judgment information for showing a screen is necessary or not in accordance with the user input operation; and
wherein, in the step of judging, judging whether a screen is necessary or not based on the judgment.

10. The portletization support method as claimed in claim 6 further comprising:
providing temporary necessary or unnecessary judgment results for all targeted screens to be judged or some of the targeted screens when a user judges whether a screen of a web application is necessary or not,
wherein, in the step of judging, judging whether other screens are necessary or unnecessary on the basis of the temporary judgment results provided in the step of providing the temporary judgment result;
measuring how many other screens are temporarily judged in the step of judging,
counting the number; and
displaying screens having a large number of counts that is given through the measurement and counting of the counting step in order to prompt the user to make a judgment.

11. A non-transitory computer readable storage medium storing a portletization support program making a computer execute:
a information storing processing which stores screen information and link information,
wherein the screen information shows a top screen on a web application accompanied by a plurality of screens or a certain selected part within the top screen and link information shows link relationships between the top screen or the certain selected part of the screen information and a screen connected to a link which derives from the top screen or the certain selected part;
a judgment rule storing processing which stores judgment rules that show whether a screen is necessary or not in accordance with a user input operation; and
a judgment processing which judges dependency relationships based on the link information and judges necessary screens or unnecessary screens based on the judgment rules and the dependency relationships,
wherein, in the judgment processing, judging whether each screen is necessary or not by recursively making the judgment.

12. The non-transitory computer readable storage medium as claimed in claim 11,
wherein, in the judgment processing, tracing a link from the top screen to a screen that is judged to be necessary and judging a screen that is a unique relay point as a necessary screen.

13. The non-transitory computer readable storage medium as claimed in claim 11,
wherein, in the judgment processing, judging a screen has a link only from a screen that is judged to be unnecessary as an unnecessary screen.

14. The non-transitory computer readable storage medium as claimed in claim 11,
wherein, in the judgment rule storing processing, storing further information which shows judgment rules between screens that are necessary for judging whether a screen is necessary or not as well as judgment information for showing a screen is necessary or not in accordance with the user input operation; and
wherein, in the judgment processing, judging whether a screen is necessary or not based on the judgment rules.

15. The non-transitory computer readable storage medium as claimed in claim 11 further comprising:
a temporary judgment result providing processing that provides temporary necessary or unnecessary judgment results for all targeted screens to be judged or some of the targeted screens when a user judges whether a screen of a web application is necessary or not,
wherein, in the judgment processing, judging whether other screens are necessary or unnecessary on the basis of the temporary judgment results provided in the temporary judgment result providing processing;
a count processing that measures how many other screens are temporarily judged in the judgment processing and counts the number; and
a display control processing that causes a display unit to display screens having a large number of counts that is given through the measurement and counting of the count unit in order to prompt the user to make a judgment.
